(19) United States
(12) Patent Application Publication
(10) Pub. No.: US 2018/0364658 A1
(43) Pub. Date: Dec. 20, 2018

(54) ADAPTIVE CONTROL OF HVAC SYSTEM

(71) Applicant: CARRIER CORPORATION, Palm Beach Gardens, FL (US)

(72) Inventors: Emile Simon, Cork (IE); Marcin Cychowski, Cork (IE)

(21) Appl. No.: 16/061,946

(22) PCT Filed: Dec. 7, 2016
(86) PCT No.: PCT/US16/65301

§ 371 Date: Jun. 13, 2018

Related U.S. Application Data
(60) Provisional application No. 62/269,155, filed on Dec. 18, 2015.

(51) Int. Cl. G05B 13/04; G05B 13/02; G05B 17/02; F24F 11/30

(52) U.S. Cl. CPC G05B 13/048; G05B 13/026; G05B 17/02; G05B 2219/2648; G05B 2219/2614; G05B 2219/2638; F24F 11/30

(57) ABSTRACT

A control system for an HVAC system having a plurality of HVAC components comprises a controller having a processor and a memory, the controller in signal communication with at least one of the plurality of HVAC components, the controller configured to: determine an aggregate demand of the HVAC system; determine an initial setpoint in response to the aggregate demand; determine a demand forecast in response to the aggregate demand; determine a setpoint offset in response to the demand forecast; generate an adaptive setpoint by combining the initial setpoint and the setpoint offset; and provide the adaptive setpoint to the at least one of the plurality of HVAC components.

### TECHNICAL FIELD

The subject matter disclosed herein relates to heating, ventilation, and air conditioning (HVAC) systems and, more specifically, to the control of an HVAC system.

### BACKGROUND

In some known heating, ventilation, and air conditioning (HVAC) systems, equipment setpoints are typically fixed or weather compensated (i.e., determined based on outdoor air temperature) without any feedback from other systems. As such, the produced heating/cooling capacity may deviate from a building demand corresponding to a desired building comfort level. Similarly, the authority of the capacity production and distribution system (e.g., the effort exerted by the HVAC system), which is determined via fluid flows/pressures and temperatures, may be unnecessarily high, so a lower authority could be sufficient to maintain the building comfort. The capacity deviations and the high authorities, due to their corresponding inefficient equipment operation or other energy losses, may result in increased energy consumption and cost.

### BRIEF DESCRIPTION

According to one embodiment, a control system for an HVAC system having a plurality of HVAC components comprises a controller having a processor and a memory, the controller in signal communication with at least one of the plurality of HVAC components, the controller configured to: determine an aggregate demand of the HVAC system; determine an initial setpoint in response to the aggregate demand; determine a demand forecast in response to the aggregate demand; determine a setpoint offset in response to the demand forecast; generate an adaptive setpoint by combining the initial setpoint and the setpoint offset; and provide the adaptive setpoint to the at least one of the plurality of HVAC components.

In addition to one or more of the features described above, or as an alternative, further embodiments may include wherein the controller is configured to update the adaptive setpoint at predetermined time intervals.

In addition to one or more of the features described above, or as an alternative, further embodiments may include wherein determining the demand forecast comprises applying a model-free technique to one or more past values of the aggregate demand and a current aggregate demand.

In addition to one or more of the features described above, or as an alternative, further embodiments may include wherein determining the demand forecast comprises applying a model-based technique to estimate a model of the HVAC system and use the model to estimate the demand forecast in response to the aggregate demand.

In addition to one or more of the features described above, or as an alternative, further embodiments may include wherein determining the setpoint offset comprises (i) if the demand forecast indicates an increasing demand of the conditioned space, then selecting a setpoint offset to increase authority of the HVAC system and (ii) if the demand forecast indicates a decreasing demand of the conditioned space, then selecting a setpoint offset to decrease authority of the HVAC system.

In addition to one or more of the features described above, or as an alternative, further embodiments may include wherein determining the setpoint offset comprises selecting the setpoint offset in response to whether the demand forecast is within a desired region or within a distance to a desired value.

In addition to one or more of the features described above, or as an alternative, further embodiments may include wherein determining the setpoint offset comprises adjusting the setpoint offset by a fixed value.

In addition to one or more of the features described above, or as an alternative, further embodiments may include wherein determining the setpoint offset comprises using a formula determining a value for adjusting the setpoint offset.

In addition to one or more of the features described above, or as an alternative, further embodiments may include wherein determining the setpoint offset comprises using a control process to stabilize the demand forecast.

In addition to one or more of the features described above, or as an alternative, further embodiments may include wherein determining the setpoint offset comprises determining that the adaptive setpoint exceeds a range and re-determining the setpoint offset such as the resulting adaptive setpoint does not exceed the range.

In addition to one or more of the features described above, or as an alternative, further embodiments may include wherein the controller is configured to filter the adaptive setpoint prior to providing the adaptive setpoint to the at least one of the plurality of HVAC components.

According to another embodiment, a method of controlling an HVAC system having a plurality of HVAC components and a controller in signal communication with the plurality of HVAC components comprises determining an aggregate demand of the HVAC system; determining an initial setpoint in response to the aggregate demand; determining a demand forecast in response to the aggregate demand; determining a setpoint offset in response to the demand forecast; generating an adaptive setpoint by combining the initial setpoint and the setpoint offset; and providing the adaptive setpoint to at least one of the plurality of HVAC components.

In addition to one or more of the features described above, or as an alternative, further embodiments may include updating the adaptive setpoint at predetermined time intervals.

In addition to one or more of the features described above, or as an alternative, further embodiments may include wherein determining the demand forecast comprises applying a model-free technique to one or more past values of the aggregate demand and a current aggregate demand.

In addition to one or more of the features described above, or as an alternative, further embodiments may include wherein determining the demand forecast comprises applying a model-based technique to estimate a model of the HVAC system and use the model to estimate the demand forecast in response to the aggregate demand.

In addition to one or more of the features described above, or as an alternative, further embodiments may include wherein determining the setpoint offset comprises (i) if the demand forecast indicates an increasing demand of the conditioned space, then selecting a setpoint offset to increase authority of the HVAC system and (ii) if the demand forecast indicates a decreasing demand of the conditioned space, then selecting a setpoint offset to decrease authority of the HVAC system.

In addition to one or more of the features described above, or as an alternative, further embodiments may include wherein determining the setpoint offset comprises selecting the setpoint offset in response to whether the demand forecast is within a desired region or within a distance to a desired value.

In addition to one or more of the features described above, or as an alternative, further embodiments may include wherein determining the setpoint offset comprises adjusting the setpoint offset by a fixed value.

In addition to one or more of the features described above, or as an alternative, further embodiments may include wherein determining the setpoint offset comprises using a formula determining a value for adjusting the setpoint offset.

In addition to one or more of the features described above, or as an alternative, further embodiments may include wherein determining the setpoint offset comprises using a control process to stabilize the demand forecast.

In addition to one or more of the features described above, or as an alternative, further embodiments may include wherein determining the setpoint offset comprises determining that the adaptive setpoint exceeds a range and re-determining the setpoint offset such as the resulting adaptive setpoint does not exceed the range.

In addition to one or more of the features described above, or as an alternative, further embodiments may include filtering the adaptive setpoint prior to providing the adaptive setpoint to the at least one of the plurality of HVAC components.

According to another embodiment, a computer program product is tangibly embodied on a computer readable medium, the computer program product including instructions that, when executed by a processor, cause the processor to perform operations comprising determining an aggregate demand of the HVAC system; determining an initial setpoint in response to the aggregate demand; determining a demand forecast in response to the aggregate demand; determining a setpoint offset in response to the demand forecast; generating an adaptive setpoint by combining the initial setpoint and the setpoint offset; and providing the adaptive setpoint to at least one of the plurality of HVAC components.

Technical effects of embodiments of the present disclosure include adaptive control of an HVAC system.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of embodiments are apparent from the following detailed description taken in conjunction with the accompanying drawings in which:

FIG. 1 depicts an HVAC system in an exemplary embodiment;

FIG. 2 depicts a control diagram in an exemplary embodiment;

FIG. 3 depicts determining aggregated demand in an exemplary embodiment; and

FIG. 4 is a flow chart illustrating a method of controlling the system shown in FIG. 1 in an exemplary embodiment.

### DETAILED DESCRIPTION

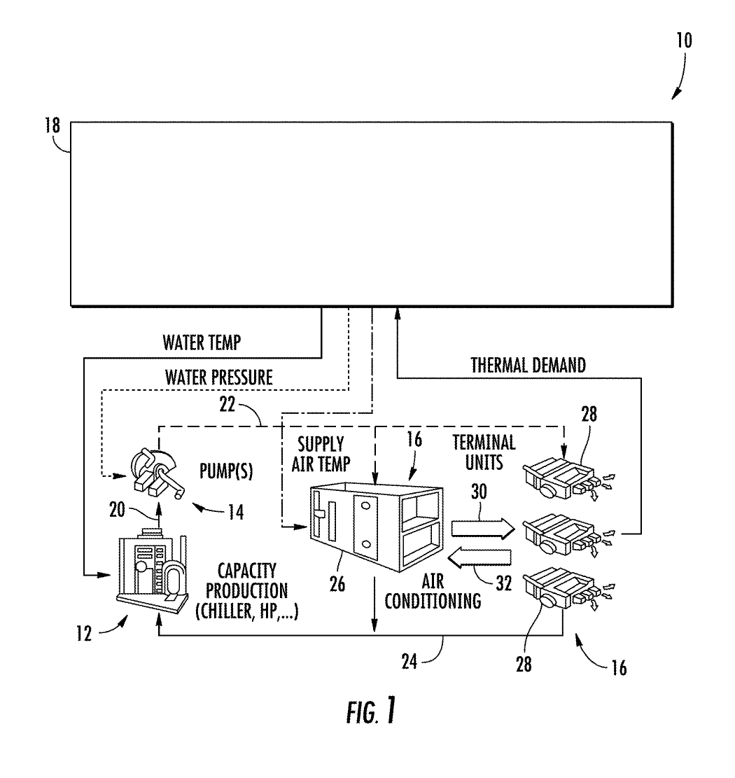

FIG. 1 illustrates an exemplary HVAC system 10 that generally includes a capacity generation plant 12, a fluid circulation pump 14, ventilation equipment 16, and a controller 18. The HVAC system 10 of FIG. 1 is just one example of an HVAC system, and it is understood that embodiments are not limited to the particular components and configuration depicted in FIG. 1. A capacity generation plant 12 conditions (i.e., heats/cools) a heat transfer fluid such as water and supplies the conditioned fluid to pump 14 via a conduit 20. Pump 14 subsequently supplies the conditioned fluid to ventilation equipment 16 (via a supply conduit 22) where the conditioned fluid is utilized to condition air forced through ventilation equipment 16. The conditioned air is then used to adjust the temperature of a building or structure associated with HVAC system 10. The fluid is then returned to capacity generation plant 12 via a return conduit 24 where the fluid is re-conditioned. Controller 18 is configured to coordinate the operation of capacity generation plant 12, pump 14, and ventilation equipment 16 with a demand of the building to reduce energy consumption through improved system efficiency. Although the HVAC system 10 is referred to as conditioning a building, embodiments may be more generally referred to as conditioning a space, such as a room, an automobile, an aircraft, etc.

Capacity generation plant 12 may be, for example a heat pump, a chiller, or a boiler. However, capacity generation plant 12 may be any type of capacity generation plant that enables HVAC system 10 to function as described herein. Capacity generation plant 12 is configured to heat or cool a heat transfer fluid (e.g., water) to facilitate environmental conditioning of the buildings. As such, capacity generation plant 12 may be controlled to selectively adjust the temperature of the heat transfer fluid.

Fluid circulation pump 14 is configured to supply the heat transfer fluid from capacity generation plant 12 to ventilation equipment 16. Pump 14 may be controlled to selectively adjust the pressure (or flow) of the heat transfer fluid. Ventilation equipment 16 may be any suitable equipment to supply conditioned air to selected zones or areas of the building. For example, in the illustrated embodiment, ventilation equipment 16 includes an air handling unit (AHU) 26 and a plurality of terminal units 28 connected via air ducts (not shown) to that AHU 26. AHU 26 is configured to receive outside air and supply the outside air (via a supply conduit 30) to one or more terminal units 28, which condition the air and supply it to the zones associated with the respective terminal unit(s) 28. The conditioned air is subsequently returned to AHU 26 via a return conduit 32 where it may be recycled or exhausted to the atmosphere. In the illustrated embodiment, terminal units 28 are fan coil units. However, terminal units 28 may be any suitable equipment that enables HVAC system 10 to function as described herein. For example, terminal units 28 may be fan coil units (FCUs), air terminal units (ATUs), variable air volume systems (VAV), or even AHUs.

Controller 18 may be a system-level controller configured to adaptively adjust operational setpoints of capacity generation plant 12, pump 14, and ventilation equipment 16 based on load conditions and a thermal demand of the building. For example, a setpoint of plant 12 may be a fluid supply temperature, a setpoint of pump 14 may be a fluid pressure or flow, and a setpoint of equipment 16 may be a valve or damper opening, a fan speed, a supply air flow and/or temperature setpoint for that equipment for a room or zone. As used herein, the term controller refers to an application specific integrated circuit (ASIC), an electronic circuit, a processor (shared, dedicated, or group) and memory that executes one or more software or firmware programs, a combinational logic circuit, and/or other suitable components that provide the described functionality.

In the exemplary embodiment, controller 18 facilitates adjusting the setpoints of capacity generation plant 12, pump 14, and ventilation equipment 16. It is understood that, depending on the application and environment, controller 18 may adaptively adjust a wide variety of setpoints of an HVAC system, and embodiments are not limited to the particular setpoints discussed herein.

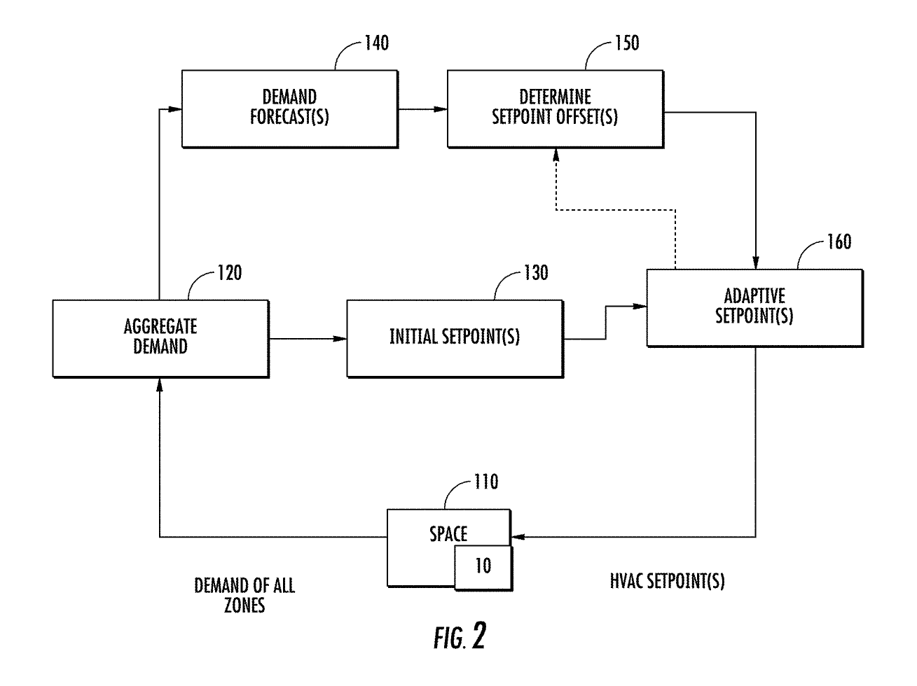

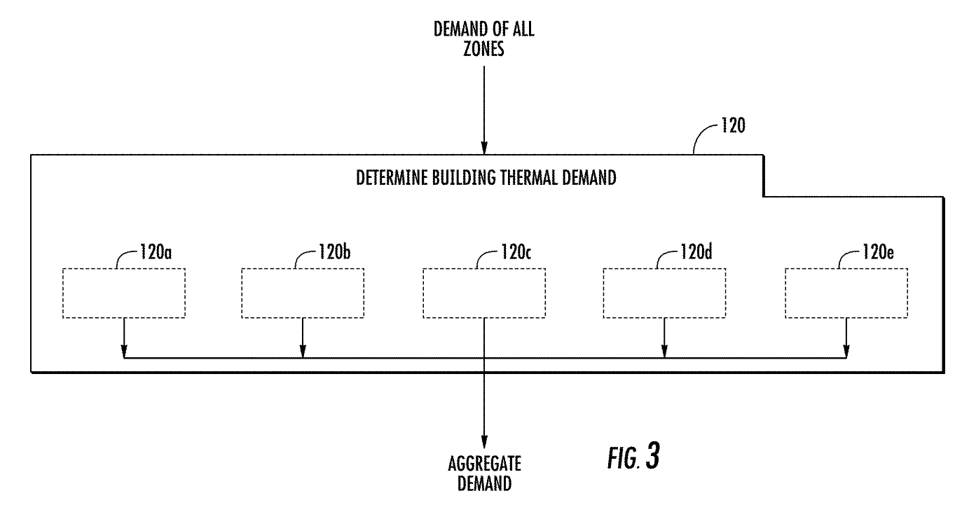

FIG. 2 depicts a control diagram executed by the controller 18 in an exemplary embodiment. The space to be conditioned (e.g. a building) is depicted at 110, and includes components of the HVAC system 10. At 120, the controller 18 determines the aggregate demand for HVAC conditioning of space 110. Determining the aggregate demand is described in further detail herein with reference to FIG. 3. At 130, the controller 130 determines initial setpoint(s) based on the aggregate demand from 120. The processing at 130 may include using static resources such as fixed rules, fixed maps, look up tables, etc., along with environmental measurements, such as outside air temperature. At 140, the controller 18 determines a demand forecast for space 110, described in further detail herein. At 150, the controller 18 determines one or more setpoint offsets. The determination of the one or more setpoint offsets is described in further detail herein. At 160, the controller 18 generates adaptive setpoint(s) by combining the initial setpoint(s) from 130 with the setpoint offset(s) from 150. At 160, the controller 18 may also determine if the adaptive setpoint(s) exceed one or more ranges. If so, flow proceeds back to 150 to adjust the setpoint offset(s), which are then used again to determine the adaptive setpoint(s) at 160. Once the adaptive setpoint(s) determined at 160 do not exceed the one or more ranges, the adaptive setpoint(s) are provided to at least one HVAC component in space 110. The controller 18 may execute the control routine periodically (e.g., every 5 minutes).

FIG. 3 depicts determining the aggregate demand, performed at 120 of FIG. 2, in an exemplary embodiment. At 120, the controller 18 determines the current aggregate demand, which is the total thermal heating or cooling demand required by the building/system served by the HVAC component under consideration (e.g., 12, 14, 16). The current building demand may be determined in various ways as represented by 120a-120e.

For example, at 120a, controller 18 determines the current building demand by:

$$Δ {T}_{Cool} = \frac{{\sum }^{NFCooling} Δ {T}_{i}}{N totFCUs} or Δ {T}_{Heat} = \frac{{\sum }^{NFHeating} Δ {T}_{i}}{N tot FCUs} , \qquad Equation ( 1 )$$

where NFCooling or NFHeating are the set of terminal units 28 in cooling or heating demand, respectively, ΔTᵢ=RAT_{sp,i}−RATᵢ is the difference between the room/zone air temperature setpoint RAT_{sp,i} and the measured room air temperature RATᵢ (with i referring to the terminal unit number), and NtotFCUs being the total number of terminal units 28 being connected to and served by the HVAC component (i.e., the fixed number of terminal units 28, which is always larger or equal to the number of units 28 currently in heating or cooling demand).

At 120b, controller 18 determines the current building demand by:

$$Δ {T}_{Cool} = \frac{{\sum }^{NFCooling} {V}_{i} Δ {T}_{i}}{V tot} or Δ {T}_{Heat} = \frac{{\sum }^{NFHeating} Vi Δ {T}_{i}}{V tot } , \qquad Equation ( 2 )$$

where the current building demand is calculated the same as in Equation (1), except where the ΔTᵢ are weighted according to a sizing factor Vi for each terminal unit 28 (zone). These weighting factors Vi can be, for example, the unit rated capacity, the area or the volume of the zone served by the terminal unit 28, or a priority measure chosen by the building owner. The Vtot measure is the sum of all the weighting factors over all the relevant terminal units 28 installed in the building/system 10 (i.e. connected to the HVAC component being coordinated with these terminal units 28). For the particular cases where Vi is equal to 1, or the area of the zone or the volume of the zone served by that terminal unit 28, then Vtot is equal to the total number of terminal units 28 installed, or the total building surface or volume served (through the terminal units) by the coordinated HVAC component, respectively.

At 120c, controller 18 determines the current building demand utilizing Equation (2), but where ΔTᵢ is replaced by another relevant measure of the demand of terminal unit 28 (in the relevant heating/cooling mode). All signals measured at the terminal unit 28 could potentially be leveraged to determine its demand. In particular, such value of demand may be: fan(s) speed(s), valve(s) or damper(s) openings, electrical heater(s) usage of the terminal unit, temperature(s) of the air going in or out of the unit, a measure of the capacity(ies) or power used by the terminal unit, a measure of temperatures and flows of fluids through the unit, or a combination thereof.

At 120d, the controller 18 determines the current building demand by utilizing HVAC component (e.g., plant 12, pump 14, equipment 16) measurements in addition to or instead of terminal unit measurements in steps 120a-120c. Such measurements of the HVAC component may be: the fan(s) speed(s), the valve(s) or damper(s) openings, the electrical heater(s) usage of the terminal unit, the temperature(s) of the air going in or out of the unit, the measure of the capacity(ies) or power used by the terminal unit, the measure of temperatures and flows of fluids through the unit, or a combination thereof.

At 120e, the controller 18 determines the current building demand by a combination of one or more of steps 120a-120d. The aggregate demand derived at 120 is then used at both 130 and 140, as shown in FIG. 2.

Referring to FIG. 2, the controller 18 uses the aggregate demand derived at 120 to determine initial setpoint(s) at 130. The processing at 130 may include using static resources such as fixed rules, fixed maps, look up tables, etc., that convert the aggregate demand from 120 to one or more initial setpoints.

At 140, the controller 18 also uses the aggregate demand derived at 120 to determine a demand forecast for space 110. In one embodiment, the controller 18 determines the demand forecast using a model-free technique, such as a linear interpolation or regression of one or several past values of the aggregate demand and a current value of the aggregate demand. In another embodiment, the controller 18 determines the demand forecast using a model-based determination. The model-based determination includes first estimating a dynamic model of the system via system estimation techniques and data of past system operation. Once this model has been estimated, this model and the current and past model inputs values can be used to estimate the demand forecast in response to the aggregate demand derived at 120.

At 150, the controller 18 determines one or more setpoint offsets. When the controller 18 first begins operating, the setpoint offset(s) are initialized to zero. The setpoint offset(s) are then continually updated from a previous value of the setpoint offset(s). In one embodiment, if the demand forecast from 140 indicates an increased demand (e.g., increased authority) of the conditioned space 110 (e.g., a need for more cooling), then the setpoint offset(s) are selected to increase authority of the HVAC system (e.g., lower a chiller temperature and/or higher pump pressure). If the demand forecast from 140 indicates a decreased demand (e.g., decreased authority) of the conditioned space 110 (e.g., desired cooling met or exceeded), then the setpoint offset(s) are selected to decrease authority of the HVAC system (e.g., raise chiller temperature and/or lower pump pressure). In another embodiment, the setpoint offset(s) may be selected based on a region in which the current or forecasted demand(s) should lie or a distance between the demand forecast(s) and desired value(s). The controller 18 can then increase or decrease the setpoint offset(s) keep the HVAC demand inside the desired region or within a distance between the demand forecast(s) and desired value(s). Both techniques may be used in conjunction as well.

The controller 18, once determining whether to increase or decrease the setpoint offset(s), also determines an amount by which to increase or decrease the setpoint offset(s). In one embodiment, the setpoint offset(s) are adjusted based on fixed values (such as 1° C. or 10 kPa). In another embodiment, the controller 18 determines a value for the setpoint offset(s) using a formula involving the current, past and forecasted values of the building demand. In yet another embodiment, the controller 18 determines a value for the setpoint offset(s) using an existing control process (e.g., PID control), such that the current demand stabilizes around a given setpoint.

The controller 18 may also adjust the setpoint offset(s) based on feedback from 160. If an adaptive setpoint (i.e., the combination of an initial setpoint and a setpoint offset) exceeds a range, then the controller 18 will re-determine the setpoint offset at 150. This is shown in FIG. 2 as a dashed feedback line from 160 to 150. The controller 18 retro-actively adjusts the current setpoint offset(s) such that the adaptive setpoint(s) at 160 falls in the desired given range(s). The range(s) typically depend on equipment specifications or are user-defined. The range(s) can furthermore be varied (made larger or narrower) depending on adequately chosen reference signal(s) (such as the outside temperature or the aggregate demand).

At 160, the controller 18 combines the initial setpoint(s) 130 with the setpoint offset(s) from 150 to obtain the adaptive setpoint(s). As noted above, at 160 the controller 18 may also compare the adaptive setpoint(s) to one or more ranges, and generate an error signal if the adaptive setpoint(s) exceed one or more ranges. The setpoint offset(s) are then re-determined at 150, which then results in 160 in the adaptive setpoint(s) falling within the desired range(s). In another embodiment, the adaptive setpoint(s) can be processed through a dynamic filter before being sent to the HVAC equipment (such as a low-pass filter that rejects undesired fast setpoint(s) variations).

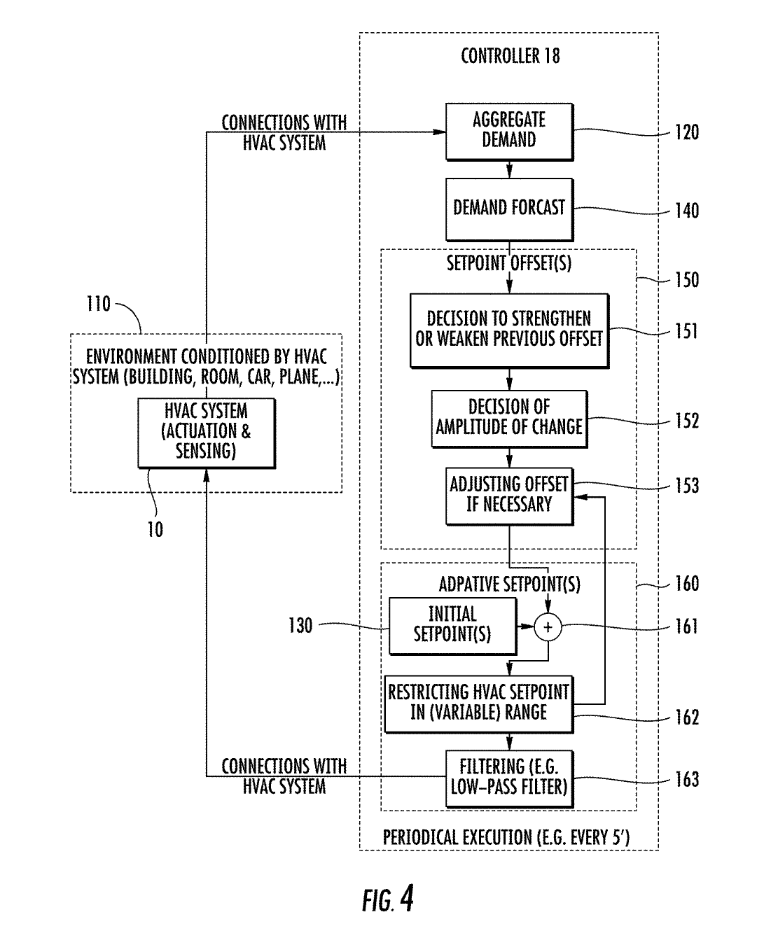

FIG. 4 depicts processing of the controller 18 in a flowchart format, in an exemplary embodiment. Elements of FIG. 4 are similar to those in FIG. 2, and similar reference numerals are employed. The space to be conditioned is depicted at 110. At 120, the controller 18 determines the aggregate demand for HVAC conditioning of space 110. At 130, the controller 130 determines an initial setpoint(s) based on the aggregate demand from 120. The processing at 130 may include using static resources such as fixed rules, fixed maps, look up tables, etc. At 140, the controller 18 determines a demand forecast for space 110. At 150, the controller 18 determines one or more setpoint offsets. The processing at 150 may include determining whether to increase or decrease the setpoint offset at 151, determining the amount or amplitude of change in the setpoint offset(s) at 152 and/or adjusting the setpoint offset(s) at 153.

At 160, the controller 18 generates adaptive setpoint(s) by combining the initial setpoint(s) from 130 with the setpoint offset(s) from 150. At 160, the controller 18 may also determine if the adaptive setpoint(s) exceed one or more ranges. The processing at 160 may include combining the initial setpoint(s) 130 with the setpoint offset(s) at 161, limiting the setpoint offset(s) if the adaptive setpoint(s) exceed one or more ranges at 162 and filtering the adaptive setpoint(s) at 163.

Embodiments describe herein provide a control system and method that allows HVAC setpoints to be adjusted adaptively to both meet comfort demands and reduce energy consumption. Embodiments balance energy consumption and comfort, in a manner driving the system (including both the space conditioned 110 and HVAC system 10) behavior to go periodically through states where the comfort could not be improved without increasing power usage, or the power usage could not be decreased without decreasing comfort.

For any given HVAC system, the current embodiments can be used one or multiple times, to control one or several equipment of the system, separately or simultaneously. Each of these different applications can of course leverage different embodiments of the current disclosure, and these different applications can have common steps or otherwise leverage each other.

As described above, the exemplary embodiments can be in the form of processor-implemented processes and devices for practicing those processes, such as a processor of controller 18. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the exemplary embodiments. When implemented on a general-purpose microprocessor, the computer program code segments configure the microprocessor to create specific logic circuits.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments have been described, it is to be understood that aspects of the disclosure may include only some of the described embodiments. Accordingly, the disclosure is not to be seen as limited by the foregoing description, but is only limited by the scope of the appended claims.

1. A control system for an HVAC system having a plurality of HVAC components, the control system comprising:
a controller having a processor and a memory, the controller in signal communication with at least one of the plurality of HVAC components, the controller configured to:
determine an aggregate demand of the HVAC system;
determine an initial setpoint in response to the aggregate demand;
determine a demand forecast in response to the aggregate demand;
determine a setpoint offset in response to the demand forecast;
generate an adaptive setpoint by combining the initial setpoint and the setpoint offset; and
provide the adaptive setpoint to the at least one of the plurality of HVAC components.

2. The control system of claim 1, wherein the controller is configured to update the adaptive setpoint at predetermined time intervals.

3. The control system of claim 1, wherein determining the demand forecast comprises applying a model-free technique to one or more past values of the aggregate demand and a current aggregate demand.

4. The control system of claim 1, wherein determining the demand forecast comprises applying a model-based technique to estimate a model of the HVAC system and use the model to estimate the demand forecast in response to the aggregate demand.

5. The control system of claim 1, wherein determining the setpoint offset comprises (i) if the demand forecast indicates an increasing demand of the conditioned space, then selecting a setpoint offset to increase authority of the HVAC system and (ii) if the demand forecast indicates a decreasing demand of the conditioned space, then selecting a setpoint offset to decrease authority of the HVAC system.

6. The control system of claim 1, wherein determining the setpoint offset comprises selecting the setpoint offset in response to whether the demand forecast is within a desired region or within a distance to a desired value.

7. The control system of claim 1, wherein determining the setpoint offset comprises adjusting the setpoint offset by a fixed value.

8. The control system of claim 1, wherein determining the setpoint offset comprises using a formula determining a value for adjusting the setpoint offset.

9. The control system of claim 1, wherein determining the setpoint offset comprises using a control process to stabilize the demand forecast.

10. The control system of claim 1, wherein determining the setpoint offset comprises determining that the adaptive setpoint exceeds a range and re-determining the setpoint offset such as the resulting adaptive setpoint does not exceed the range.

11. The control system of claim 1, wherein the controller is configured to filter the adaptive setpoint prior to providing the adaptive setpoint to the at least one of the plurality of HVAC components.

12. A method of controlling an HVAC system having a plurality of HVAC components and a controller in signal communication with the plurality of HVAC components, the method comprising:
determining an aggregate demand of the HVAC system;
determining an initial setpoint in response to the aggregate demand;
determining a demand forecast in response to the aggregate demand;
determining a setpoint offset in response to the demand forecast;
generating an adaptive setpoint by combining the initial setpoint and the setpoint offset; and
providing the adaptive setpoint to at least one of the plurality of HVAC components.

13. The method of claim 12, further comprising updating the adaptive setpoint at predetermined time intervals.

14. The method of claim 12, wherein determining the demand forecast comprises applying a model-free technique to one or more past values of the aggregate demand and a current aggregate demand.

15. The method of claim 12, wherein determining the demand forecast comprises applying a model-based technique to estimate a model of the HVAC system and use the model to estimate the demand forecast in response to the aggregate demand.

16. The method of claim 12, wherein determining the setpoint offset comprises (i) if the demand forecast indicates an increasing demand of the conditioned space, then selecting a setpoint offset to increase authority of the HVAC system and (ii) if the demand forecast indicates a decreasing demand of the conditioned space, then selecting a setpoint offset to decrease authority of the HVAC system.

17. The method of claim 12, wherein determining the setpoint offset comprises selecting the setpoint offset in response to whether the demand forecast is within a desired region or within a distance to a desired value.

18. The method of claim 12, wherein determining the setpoint offset comprises adjusting the setpoint offset by a fixed value.

19. The method of claim 12, wherein determining the setpoint offset comprises using a formula determining a value for adjusting the setpoint offset.

20. The method of claim 12, wherein determining the setpoint offset comprises using a control process to stabilize the demand forecast.

21. The method of claim 12, wherein determining the setpoint offset comprises determining that the adaptive setpoint exceeds a range and re-determining the setpoint offset such as the resulting adaptive setpoint does not exceed the range.

22. The method of claim 12, further comprising filtering the adaptive setpoint prior to providing the adaptive setpoint to the at least one of the plurality of HVAC components.

23. A computer program product tangibly embodied on a computer readable medium, the computer program product including instructions that, when executed by a processor, cause the processor to perform operations comprising:
determining an aggregate demand of the HVAC system;
determining an initial setpoint in response to the aggregate demand;
determining a demand forecast in response to the aggregate demand;
determining a setpoint offset in response to the demand forecast;
generating an adaptive setpoint by combining the initial setpoint and the setpoint offset; and
providing the adaptive setpoint to at least one of the plurality of HVAC components.
